(19) United States
(12) Patent Application Publication
(10) Pub. No.: US 2006/0046644 A1
(43) Pub. Date: Mar. 2, 2006

(54) Software-defined repeater for use in a wireless network

(75) Inventors: Yong-Woo Chung, Frisco, TX (US); Seong Eun Kim, Plano, TX (US); Paul Nelson, Frisco, TX (US)

Correspondence Address: DOCKET CLERK, P.O. DRAWER 800889, DALLAS, TX, 75380, US

(73) Assignee: SAMSUNG ELECTRONICS CO., LTD., Suwon-city (KR)

(21) Appl. No.: 10/925,106

(22) Filed: Aug. 24, 2004

(51) Int. Cl. H04B 3/36; H04B 7/14; H04B 7/15; H04J 11/00

(52) U.S. Cl. 455/11.1; 455/7

(57) ABSTRACT

A software-defined repeater for use in a wireless network. The software-defined repeater comprises: 1) a first software-defined transceiver that receives forward channel signals transmitted by a base station and transmits reverse channel signals to the base station according to a first air interface standard; and 2) a second software-defined transceiver that receives reverse channel signals transmitted by mobile stations and transmits forward channel signals to the mobile stations according to a second air interface standard.

### TECHNICAL FIELD OF THE INVENTION

The present invention generally relates to wireless communications and, more specifically, to a software-defined repeater for use in a wireless communication network.

### BACKGROUND OF THE INVENTION

Wireless communication systems have become ubiquitous in society. Consumers use a wide range of devices and networks, including cellular phones, paging devices, personal communication services (PCS) systems, and wireless data networks. Wireless service providers are creating new markets for wireless devices and expanding existing markets by making wireless devices and services cheaper and more reliable. Wireless service providers attract new customers by reducing infrastructure costs and operating costs, by increasing handset battery life, and by improving quality of service (QoS).

Inadequate coverage is a persistent problem in the quality of service of any wireless network. Natural and man-made obstacles frequently create radio frequency (RF) “holes” in the coverage area of a wireless network. Voice and data call connections are frequently dropped when a wireless terminal, such as a cell phone or a similar mobile station, enters an RF hole. Mobile stations that are already in an RF hole may not be able to reliably establish new connections.

To improve coverage and to eliminate RF holes, wireless service providers frequently augment wireless networks with radio frequency (RF) repeaters. RF repeaters located near the edge of a cell are also used to extend the range of a base station in a wireless network. In the forward channel, an RF repeater receives signals transmitted by a base station of a wireless network, amplifies the received forward channel signals, and re-transmits the amplified forward channel signals to mobile stations in or near the RF hole or beyond the normal edge of the cell site. In the reverse channel, an RF repeater receives signals transmitted by mobile stations in or near the RF hole or beyond the edge of the cell site, amplifies the received reverse channel signals, and re-transmits the amplified reverse channel signals to the base station.

However, using RF repeaters increases infrastructure and operating costs and inhibits adaptation of the wireless network. This is due in part to the limited capabilities of existing RF repeaters. Conventional RF repeaters are limited in application because conventional RF repeaters generally support a single standard (e.g., CDMA2000) or a small family of related standards (e.g., 3GPP, GSM/EDGE with WCDMA). Also, conventional RF repeaters are often limited to one or two frequency bands. The circuits of conventional RF repeaters are not flexible enough to support a broad range of air interface standards. Thus, existing RF repeaters cannot be easily modified to accommodate new standards or changes to existing standards, such as the addition of high-speed data (3G1xEV-DV) capabilities to the CDMA2000 standard. As a result, in order to support multiple RF standards and multiple frequency bands within the same wireless network, wireless services providers often deploy different types of RF repeaters. Unfortunately, doing this increases infrastructure and operating costs.

Therefore, there is a need in the art for improved wireless networks having improved RF coverage. In particular, there is a need for an improved RF repeater that flexibly adapts to different air interface standards in a variety of wireless networks.

### SUMMARY OF THE INVENTION

The present invention provides a software-defined repeater that easily adapts to different wireless standards. A radio frequency (RF) repeater according to the principles of the present invention provides superior performance because it is software defined and may be remotely upgraded. It also may operate according to different standards simultaneously.

To address the above-discussed deficiencies of the prior art, it is a primary object of the present invention to provide a software-defined repeater for use in a wireless network. According to an advantageous embodiment, the software-defined repeater comprises: 1) a first software-defined transceiver capable of receiving forward channel signals transmitted by a base station and transmitting reverse channel signals to the base station according to a first air interface standard; and 2) a second software-defined transceiver capable of receiving reverse channel signals transmitted by a plurality of mobile stations and transmitting forward channel signals to the plurality of mobile stations according to a second air interface standard.

According to one embodiment of the present invention, the first air interface standard is the same as the second air interface standard.

According to another embodiment of the present invention, the first air interface standard is different than the second air interface standard.

According to still another embodiment of the present invention, the first software-defined transceiver is further capable of being reconfigured to transmit and to receive according to at least one air interface standard other than the first air interface standard.

According to yet another embodiment of the present invention, the second software-defined transceiver is further capable of being reconfigured to transmit and to receive according to at least one air interface standard other than the second air interface standard.

According to a further embodiment of the present invention, the first software-defined transceiver is further capable of receiving forward channel signals transmitted by the base station according to the first air interface standard and transmitting reverse channel signals to the base station according to a third air interface standard.

According to a still further embodiment of the present invention, the second software-defined transceiver is further capable of receiving reverse channel signals transmitted by the plurality of mobile stations according to the second air interface standard and transmitting forward channel signals to the mobile stations according to a fourth air interface standard.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that implements a plurality of software-defined repeaters according to the principles of the present invention;

FIG. 2 illustrates the exemplary software-defined repeaters in FIG. 1 in greater detail according to an exemplary embodiment of the present invention;

FIG. 3 illustrates in greater detail selected portions of the software-defined controller in an exemplary software-defined repeater according to an exemplary embodiment of the present invention; and

FIG. 4 is a flow diagram illustrating the operation of the exemplary software-defined repeater according to an exemplary embodiment of the present invention.

### DETAILED DESCRIPTION OF THE INVENTION

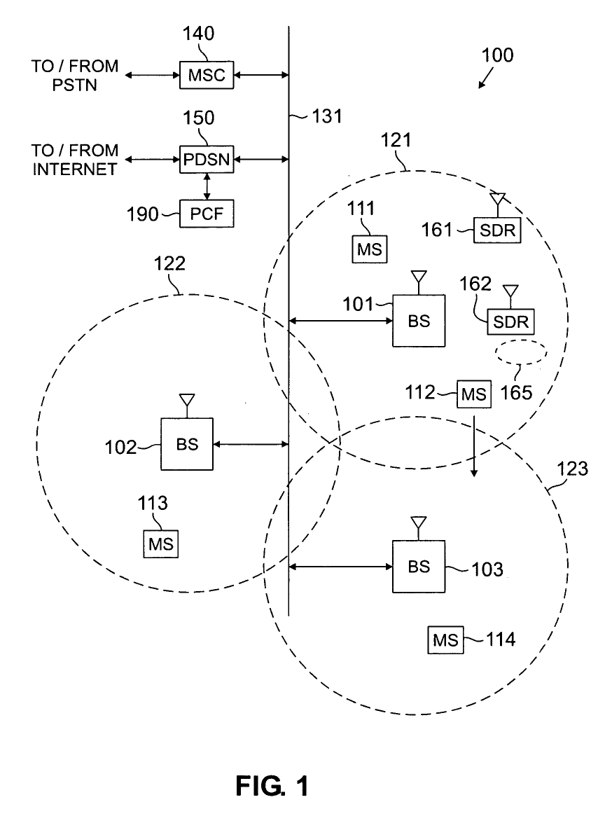

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, implements a plurality of software-defined repeaters according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 using one or more of a number of conventional standards, including, but not limited to, CDMA2000, 3G1xEV-DO, IEEE 802.11a/b/g, IEEE 802.20, IEEE 802.16, GSM/EDGE, WCDMA, TDMA, HSDPA, TD-SCDMA, CDMA One, or the like. In an advantageous embodiment of the present invention, mobile stations 111-114 are capable of receiving data traffic and/or voice traffic on two or more channels simultaneously. Mobile stations 111-114 may be any suitable wireless devices (e.g., conventional cell phones, PCS handsets, personal digital assistant (PDA) handsets, portable computers, telemetry devices) that are capable of communicating with base stations 101-103 via wireless links.

The present invention is not limited to communicating with mobile devices. The present invention also encompasses other types of wireless access terminals, including fixed wireless terminals. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., a machine monitor with wireless capability).

Dotted lines show the approximate boundaries of cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, each of cell sites 121-123 is comprised of a plurality of sectors, where a directional antenna coupled to the base station illuminates each sector. The embodiment of FIG. 1 illustrates the base station in the center of the cell. Alternate embodiments may position the directional antennas in corners of the sectors. The system of the present invention is not limited to any particular cell site configuration.

In one embodiment of the present invention, each of BS 101, BS 102 and BS 103 comprises a base station controller (BSC) and one or more base transceiver subsystem(s) (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystems in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of MSC 140, or as a stand-alone device that communicates with PDSN 150, as shown in FIG. 1. Line 131 also provides the connection path for control signals transmitted between MSC 140 and BS 101, BS 102 and BS 103 that establish connections for voice and data circuits between MSC 140 and BS 101, BS 102 and BS 103.

Communication line 131 may be any suitable connection means, including a T1 line, a T3 line, a fiber optic link, a network packet data backbone connection, or any other type of data connection. Line 131 links each vocoder in the BSC with switch elements in MSC 140. The connections on line 131 may transmit analog voice signals or digital voice signals in pulse code modulated (PCM) format, Internet Protocol (IP) format, asynchronous transfer mode (ATM) format, or the like.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102, or BS 103 to MSC 140.

In the exemplary wireless network 100, MS 111 is located in cell site 121 and is in communication with BS 101. MS 113 is located in cell site 122 and is in communication with BS 102. MS 114 is located in cell site 123 and is in communication with BS 103. MS 112 is also located close to the edge of cell site 123 and is moving in the direction of cell site 123, as indicated by the direction arrow proximate MS 112. At some point, as MS 112 moves into cell site 123 and out of cell site 121, a hand-off will occur.

Natural and man-made obstacles create radio frequency (RF) holes in the coverage area of wireless network 100. By way of example, RF hole 165 (indicated by a dotted line) exists in cell site 121. If MS 111 or MS 112 enters RF hole 165, an existing voice call or data call connection may be dropped. Also, MS 111 or MS 112 may not be able to reliably establish new call connections.

Accordingly, to eliminate RF holes, such as RF hole 165, and to extend coverage area, wireless network 100 further comprises software-defined repeater (SDR) 161 and software-defined repeater (SDR) 162. SDR 161 is disposed near the outer boundary of cell site 121 and extends the range of BS 101 to reach mobile stations that are in the vicinity of SDR 161, but just outside the coverage area of cell site 121. Deploying SDR 161 in this manner may be necessary if it would be prohibitively expensive to add a new cell site next to cell site 121. SDR 162 is disposed near the edge of RF hole 165 and improves coverage within RF hole 165. Advantageously, SDR 161 increases the strength of forward and reverse channel signals only in the vicinity of the outer edge of cell site 121 and SDR 162 increases the strength of forward and reverse channel signals only in the vicinity of RF hole 165. Thus, the amount of increased signal interference in adjacent cell sites 122 and 123 is minimal or non-existent.

As will be explained below in greater detail, SDR 161 and SDR 162 are implemented using software-defined radio components, so that SDR 161 and SDR 162 may be implemented in different types of wireless networks. This increases the reusability of SDR 161 and SDR 162 for a variety of air interface standards. Additionally, once deployed, SDR 161 and SDR 162 may be modified and updated remotely, thereby reducing the cost of modifying wireless network 100.

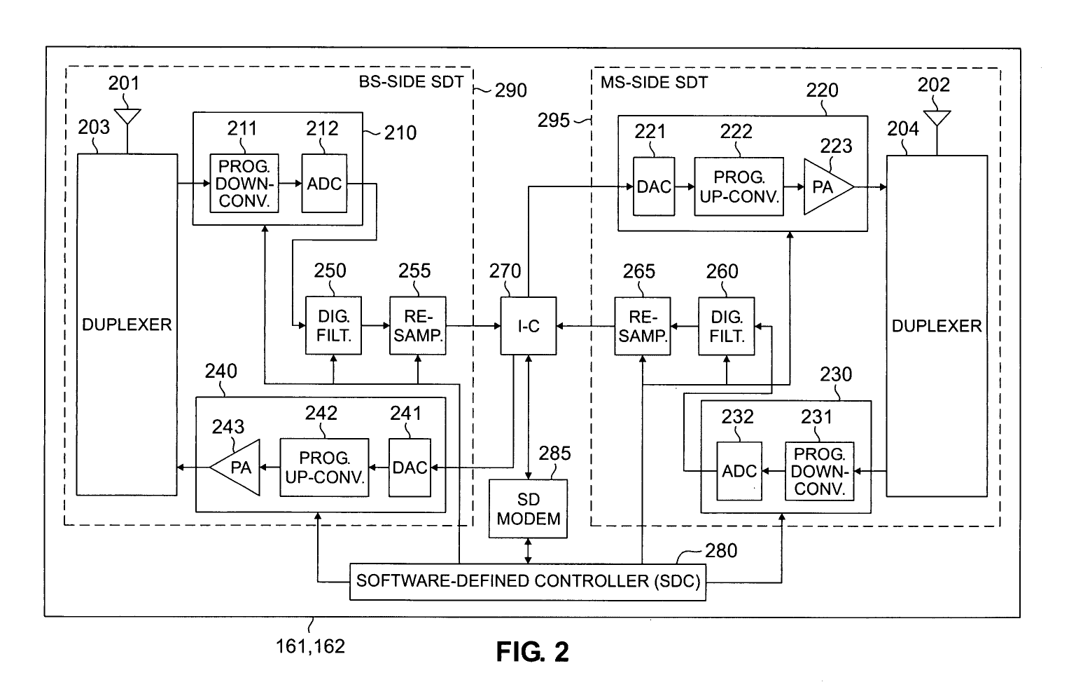

FIG. 2 illustrates exemplary software-defined repeaters 161 and 162 in greater detail according to an exemplary embodiment of the present invention. Since software-defined repeater (SDR) 161 and software-defined repeater (SDR) 162 are substantially identical, it is unnecessary and redundant to explain the operation of each SDR separately. Therefore, the explanation of the present invention that follows will generally be limited to discussion of SDR 162.

SDR 162 comprises base station (BS)-side software-defined transceiver (SDT) 290, mobile station (MS)-side software-defined transceiver (SDT) 295, interconnect (I-C) circuit 270, software-defined controller (SDC) 280 and software-defined modem (SDM) 285. BS-side SDT 290 comprises antenna 201, duplexer 203, receive path circuit block 210, transmit path circuit block 240, digital filter 250, and resampler 255. MS-side SDT 295 comprises antenna 202, duplexer 204, transmit path circuit block 220, receive path circuit block 230, digital filter 260, and resampler 265.

Receive path circuit block 210 comprises programmable down-converter 211 and analog-to-digital converter (ADC) 212. Transmit path circuit block 220 comprises digital-to-analog converter (DAC) 221, programmable up-converter 222 and power amplifier (PA) 223. Receive path circuit block 230 comprises programmable down-converter 231 and analog-to-digital converter (ADC) 232. Transmit path circuit block 240 comprises digital-to-analog converter (DAC) 241, programmable up-converter 242 and power amplifier (PA) 243.

In one embodiment of the present invention, antenna 201 is a directional antenna pointed at base station (BS) 101. Antenna 201 receives forward channel signals from BS 101 and also transmits reverse channel signals to BS 101. Antenna 202 transmits forward channel signals to a plurality of mobile stations in the vicinity of RF hole 165 (or beyond the edge of cell site 121 in the case of SDR 161). Antenna 202 also receives reverse channel signals from a plurality of mobile stations in the vicinity of RF hole 165 (or beyond the edge of cell site 121 in the case of SDR 161). In an advantageous embodiment of the present invention, duplexers 203 and 204 may be used so that each one of antennas 201 and 202 is capable of both receiving and transmitting. However, in an alternate embodiment of the present invention, separate antennas may be associated with receive path circuit block 210, transmit path circuit block 220, receive path circuit block 230, and transmit path circuit block 240. Furthermore, antennas 201 and 202 may be implemented as diversity antennas or antenna arrays in order to improve RF performance.

Programmable down-converter 211 receives a forward channel signal from antenna 201 and down-converts the RF signal to a baseband signal or an intermediate frequency (IF) signal. Down-converter 211 performs gain control and amplification as needed. ADC 212 converts the baseband signal or IF signal to a sequence of digital samples. Programmable down-converter 211 may be reprogrammed or reconfigured under software control by SDC 280 to operate according to different air interface standards and at different frequencies as described below in greater detail. The operation of ADC 212 also may be programmed or adjusted by SDC 280. ADC 212 has the performance capabilities necessary to support the most demanding of the supported standards.

The digital samples from ADC 212 are filtered by digital filter 250. The filtered digital samples may be further modulated and demodulated or resampled by resampler 255, as required. According to an advantageous embodiment of the present invention, both digital filter 250 and resampler 255 may be reprogrammed or reconfigured by SDC 280. Finally, the output of resampler 255 is passed through interconnect circuit 270 to transmit path circuit block 220.

DAC 221 of transmit path circuit block 220 converts the digital signals from receive path circuit block 210 to analog signals. The analog output from DAC 221 is up-converted to an RF signal by programmable up-converter 222. Power amplifier (PA) 223 amplifies the RF signal from programmable up-converter 222 to a suitable power level for transmission via duplexer 204 and antenna 202. Programmable up-converter 222 may be reprogrammed or reconfigured under software control by SDC 280 to operate according to different air interface standards and at different frequencies as described below in greater detail. The operation of DAC 221 also may be programmed or adjusted by SDC 280. DAC 221 has the performance capabilities necessary to support the most demanding of the supported standards.

SDR 162 is capable of simultaneously receiving signals from BS 101 and a plurality of mobile stations in the vicinity of RF hole 165 (or beyond the edge of cell site 121 in the case of SDR 161). Programmable down-converter 231 receives a reverse channel signal from antenna 202 and down-converts the RF signal to a baseband signal or an intermediate frequency (IF) signal. Down-converter 231 performs gain control and amplification as needed. ADC 232 converts the baseband signal or IF signal to a sequence of digital samples. Programmable down-converter 231 may be reprogrammed or reconfigured under software control by SDC 280 to operate according to different air interface standards and at different frequencies as described below in greater detail. The operation of ADC 232 also may be programmed or adjusted by SDC 280. ADC 232 has the performance capabilities necessary to support the most demanding of the supported standards.

The digital samples from ADC 232 are filtered by digital filter 260. The filtered digital samples may be further modulated and demodulated or resampled by resampler 265, as required. According to an advantageous embodiment of the present invention, both digital filter 260 and resampler 265 may be reprogrammed or reconfigured by SDC 280. Finally, the output of resampler 265 is passed through interconnect circuit 270 to transmit path circuit block 240.

SDR 162 is also capable of simultaneously transmiting signals to BS 101 and a plurality of mobile stations in the vicinity of RF hole 165 (or beyond the edge of cell site 121 in the case of SDR 161). DAC 241 of transmit path circuit block 240 converts the digital signals from receive path circuit block 230 to analog format. The analog output from DAC 241 is up-converted to an RF signal by programmable up-converter 242. Power amplifier (PA) 243 amplifies the RF signal from programmable up-converter 242 to a suitable power level for transmission via duplexer 203 and antenna 201. Programmable up-converter 242 may be reprogrammed or reconfigured under software control by SDC 280 to operate according to different air interface standards and at different frequencies as described below in greater detail. The operation of ADC 241 also may be programmed or adjusted by SDC 280. ADC 241 has the performance capabilities necessary to support the most demanding of the supported standards.

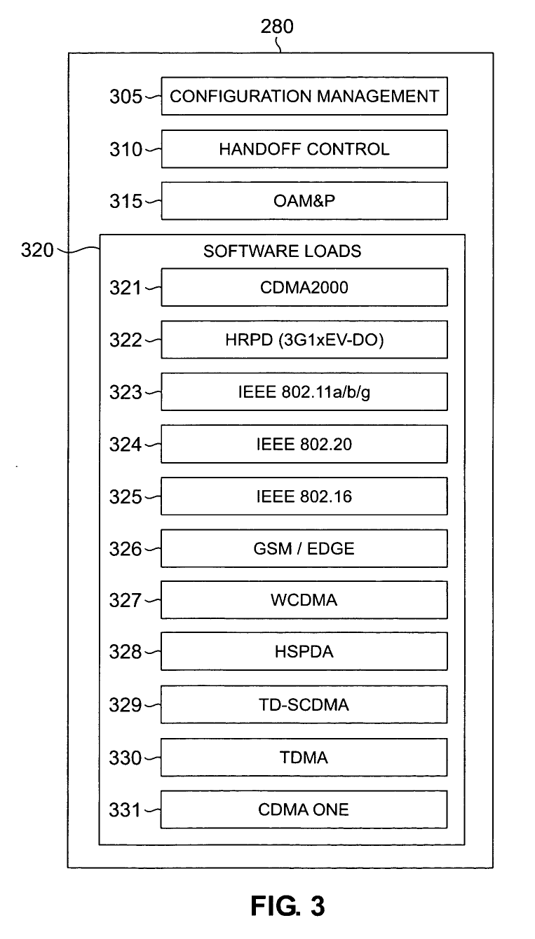

FIG. 3 illustrates in greater detail selected portions of software-defined controller (SDC) 280 in exemplary software-defined repeater (SDR) 162 according to an exemplary embodiment of the present invention. SDC 280 may be implemented in hardware, firmware or software, or some combination of at least two of the same. By way of example, SDC 280 may comprise a data processor and an associated memory that stores certain executable functions that control the operations of SDR 162.

According to an advantageous embodiment of the present invention, SDC 280 performs configuration management functions 305, handoff control functions 310, and operation, administration, maintenance and provisioning (OAM&P) functions 315. SDC 280 also stores in memory 320 a plurality of software loads associated with a variety of air interface standards. The software loads in memory 320 comprise CDMA2000 load 321, HRPD load 322, IEEE 802.11a/b/g load 323, IEEE 802.20 load 324, IEEE 802.16 load 325, GSM/EDGE load 326, WCDMA load 327, HSPDA load 328, TD-SCDMA load 329, TDMA load 330, and CDMA One load 331, among others. Those skilled in the art will recognize that these software loads are given by way of example and should not be construed as to limit the scope of the present invention. Other software loads for other air interface standards also may be present in memory 320, but are not shown.

SDC 280 communicates with BS 101 through (BS)-side software-defined transceiver (SDT) 290, using one or more user traffic channels or control channels. Software-defined modem (SDM) 285 modulates and demodulates the channels used for communication between SDR 162 and BS 101. According to an exemplary embodiment of the present invention, SDM 285 is programmable (or configurable) under software control to support all of the required standards in software loads 320.

According to an advantageous embodiment, SDC 280 programs (or configures) all of the other components in SDR 162 to support one or more selected standards in software loads 320. For example, SDC 280 may use CDMA2000 load 321 to configure receive path 210 and transmit path 240 to communicate with BS 101. Likewise SDC 280 may use the exact same air interface standard CDMA2000 load 321 to configure transmit path 220 and receive path 230 to communicate with a plurality of mobile stations in the vicinity of RF hole 165 (or beyond the edge of cell site 121).

In an alternate advantageous embodiment of the present invention it is not required that SDR 162 communicate with BS 101 according to the exact same air interface standard used to communicate with mobile stations. By way of example, SDC 280 may use WCDMA load 327 to configure BS-side SDT 290 to communicate with BS 101. At the same time, SDC 280 may use IEEE 802.11a/b/g load 323 to configure MS-side SDT 295 to communicate with a plurality of mobile stations in the vicinity of RF hole 165 (or beyond the edge of cell site 121 in the case of SDR 161).

It is recalled from the above description that SDC 280 is not limited to the plurality of software loads in memory 320, but instead may comprise other software loads for other air interface standards. According to an advantageous embodiment of the present invention, SDC 280 may communicate with BS 101 and download new software code loads over the air using BS-side SDT 290. This allows SDR 162 to support new standards and to receive remote wireless upgrades. SDC 280 also controls handoffs between BS 101 and SDR 162. According to an exemplary embodiment, SDC 280 also tests the operations of SDR 162 and reports failures to BS 101.

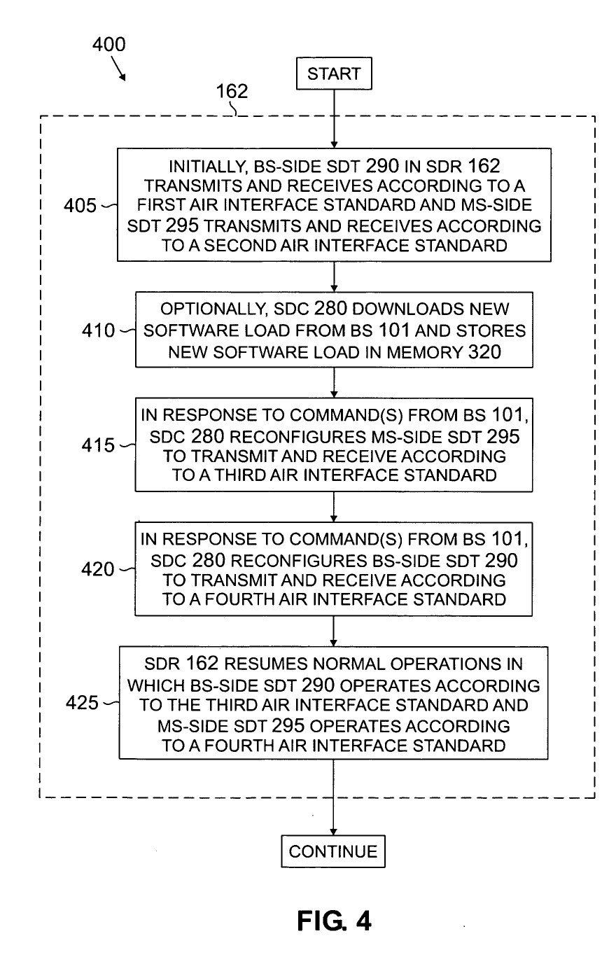

FIG. 4 depicts flow diagram 400, which illustrates the operation of exemplary software-defined repeater (SDR) 162 according to an exemplary embodiment of the present invention. Initially, base station (BS)-side software-defined transceiver (SDT) 290 in SDR 162 transmits and receives according to a first air interface standard and mobile station (MS)-side software-defined transceiver (SDT) 295 transmits and receives according to a second air interface standard (process step 405). The first and second air interface standards may be the same standard or different standards. Assuming a new standard has become available, software-defined controller (SDC) 280 optionally may download a new software load from BS 101 and store the new software load with the other software loads in memory 320 (process step 410).

At some point, SDC 280 may receive one or more command(s) from BS 101 to change configurations. In such an event, SDC 280 may reconfigure MS-side SDT 295 to transmit and receive according to a third air interface standard (process step 415). Additionally, SDC 280 may reconfigure BS-side SDT 290 to transmit and receive according to a fourth air interface standard (process step 420). The third and fourth air interface standards may be the same standard or different standards. Thereafter, SDR 162 resumes normal operations in which BS-side SDT 290 operates according to the third air interface standard and MS-side SDT 295 operates according to the fourth air interface standard (process step 425). Either of both of the third air interface standard and the fourth air interface standard may have been downloaded over the air as part of the new software load in process step 410 above.

While the exemplary embodiments of the present invention have been shown and described, it will be understood that various changes and modifications to the foregoing embodiments may become apparent to those skilled in the art without departing from the spirit and scope of the present invention. Accordingly, the invention is not limited to the embodiments disclosed, but rather by the appended claims and their equivalents.

What is claimed is:

1. For use in a wireless network, a software-defined repeater comprising:
a first software-defined transceiver capable of receiving forward channel signals transmitted by a base station according to a first air interface standard and transmitting reverse channel signals to said base station according to said first air interface standard; and
a second software-defined transceiver capable of receiving reverse channel signals transmitted by a plurality of mobile stations according to a second air interface standard and transmitting forward channel signals to said plurality of mobile stations according to said second air interface standard.

2. The software-defined repeater as set forth in claim 1, wherein said first air interface standard is the same as said second air interface standard.

3. The software-defined repeater as set forth in claim 1, wherein said first air interface standard is different than said second air interface standard.

4. The software-defined repeater as set forth in claim 1, wherein said first software-defined transceiver is further capable of being reconfigured to transmit and receive according to at least one air interface standard other than said first air interface standard.

5. The software-defined repeater as set forth in claim 4, wherein said second software-defined transceiver is further capable of being reconfigured to transmit and receive according to at least one air interface standard other than said second air interface standard.

6. The software-defined repeater as set forth in claim 5, wherein said first software-defined transceiver is further capable of receiving forward channel signals transmitted by said base station according to said first air interface standard and transmitting reverse channel signals to said base station according to a third air interface standard.

7. The software-defined repeater as set forth in claim 6, wherein said second software-defined transceiver is further capable of receiving reverse channel signals transmitted by said plurality of mobile stations according to said second air interface standard and transmitting forward channel signals to said mobile stations according to a fourth air interface standard.

8. The software-defined repeater as set forth in claim 7, wherein said third air interface standard is the same as said fourth air interface standard.

9. A wireless network comprising:
a plurality of base stations capable of communicating with a plurality of mobile stations in a coverage area of said wireless network; and
a software-defined repeater capable comprising:
a first software-defined transceiver capable of receiving forward channel signals transmitted by said a first one of said plurality of base stations according to a first air interface standard and transmitting reverse channel signals to said first base station according to said first air interface standard; and
a second software-defined transceiver capable of receiving reverse channel signals transmitted by said plurality of mobile stations according to a second air interface standard and transmitting forward channel signals to said plurality of mobile stations according to said second air interface standard.

10. The wireless network as set forth in claim 9, wherein said first air interface standard is the same as said second air interface standard.

11. The wireless network as set forth in claim 9, wherein said first air interface standard is different than said second air interface standard.

12. The wireless network as set forth in claim 9, wherein said first software-defined transceiver is further capable of being reconfigured to transmit and to receive according to at least one air interface standard other than said first air interface standard.

13. The wireless network as set forth in claim 12, wherein said second software-defined transceiver is further capable of being reconfigured to transmit and to receive according to at least one air interface standard other than said second air interface standard.

14. The wireless network as set forth in claim 13 wherein said first software-defined transceiver is further capable of receiving forward channel signals transmitted by said first base station according to said first air interface standard and transmitting reverse channel signals to said first base station according to a third air interface standard.

15. The wireless network as set forth in claim 14, wherein said second software-defined transceiver is further capable of receiving reverse channel signals transmitted by said plurality of mobile stations according to said second air interface standard and transmitting forward channel signals to said plurality of mobile stations according to a fourth air interface standard.

16. The wireless network as set forth in claim 15, wherein said third air interface standard is the same as said fourth air interface standard.

17. A method of operating a software-defined repeater comprising: 1) a first software-defined transceiver for communicating with a base station according to a first air interface standard; and 2) a second software-defined transceiver for communicating with a plurality of mobile stations according to a second air interface standard, the method comprising the steps of:
transmitting a new software load associated with a third air interface standard to the software-defined repeater;
storing the new software load in a memory in the software-defined repeater;
receiving from the base station a reconfiguration command capable of re-configuring the software-defined repeater; and
in response to receipt of the reconfiguration command, using the stored new software load to reconfigure at least one of the first software-defined transceiver and the second software-defined transceiver to communicate according to the third air interface standard.

18. The method as set forth in claim 17, wherein the first air interface standard is the same as the second air interface standard.

19. The method as set forth in claim 18, wherein the first air interface standard is different than the second air interface standard.

20. The method as set forth in claim 17, wherein the step of using the stored new software load comprises the sub-step of reconfiguring both of the first software-defined transceiver and the second software-defined transceiver to communicate according to the third air interface standard.
